(19) United States
(12) Patent Application Publication
(10) Pub. No.: US 2004/0088411 A1
(43) Pub. Date: May 6, 2004

(54) Method and system for vendor management

(76) Inventors: Deborah W. Jakubowski, Rochester Hills, MI (US); Kathryn M. Dodson, Oxford, MI (US); Richard J. Burges, Carrollton, TX (US); Alan J. Munkacsy, Okemos, MI (US); David K. Loo, Birmingham, MI (US); Wendy S. Thomson, Bloomfield Hills, MI (US)

Correspondence Address: BAKER BOTTS L.L.P., 2001 ROSS AVENUE, 6TH FLOOR, DALLAS, TX, 75201, US

(21) Appl. No.: 10/366,129

(22) Filed: Feb. 12, 2003

Related U.S. Application Data
(60) Provisional application No. 60/423,773, filed on Nov. 4, 2002.

(51) Int. Cl. G06F 15/173

(52) U.S. Cl. 709/225

(57) ABSTRACT

A method and system for vendor management are described. A standard associated with a service and a client is determined. A service management provider applies the standard to a first vendor associated with the service and manages compliance with the standard by the first vendor.

### RELATED APPLICATIONS

This application claims priority to U.S. Provisional Patent Application No. 60/423,773 entitled “Multi-Vendor Service Management” and filed Nov. 4, 2002, which is incorporated herein by reference.

### TECHNICAL FIELD

This invention relates in general to management techniques, and more specifically, to a method and system for vendor management.

### BACKGROUND

As computers have grown increasingly important in today's society, businesses have increasingly relied upon computers and other technology in support of the business. Many businesses have chosen to outsource various portions of their operations, such as information technology, to various outside vendors to control costs. Outsourced services may be provided by different vendors in a variety of ways.

### SUMMARY

According to one embodiment of the present invention, a method and system for vendor management are described. A standard associated with a service and a client is determined. A service management provider applies the standard to a first vendor associated with the service and manages compliance with the standard by the first vendor.

The present invention involves various technical advantages. Various embodiments of the present invention may provide all, some or none of these technical advantages. One such technical advantage is the capability to support commonality of operations between multiple vendors and the client of the vendors. Another technical advantage is the capability for a service management provider to enforce common operations upon all vendors so that the client may receive consistent levels of service.

### BRIEF DESCRIPTION OF THE DRAWINGS

The present invention is best understood from the detailed description which follows, taken in conjunction with the accompanying drawings, in which:

FIG. 1 is a graph illustrating a multi-vendor outsourcing environment according to one embodiment of the present invention;

FIG. 2 is a block diagram illustrating a vendor management system usage with the multi-vendor outsourcing environment according to one embodiment of the present invention;

FIG. 3 is a block diagram illustrating a service management model for vendor management according to one embodiment of the present invention;

FIG. 4 is a block diagram illustrating a Service Provider Interface usable in associating with the management model according to one embodiment of the present invention; and

FIG. 5 is a flowchart illustrating use of the service management model in the multi-vendor outsourcing environment according to one embodiment of the present invention.

### DETAILED DESCRIPTION OF THE INVENTION

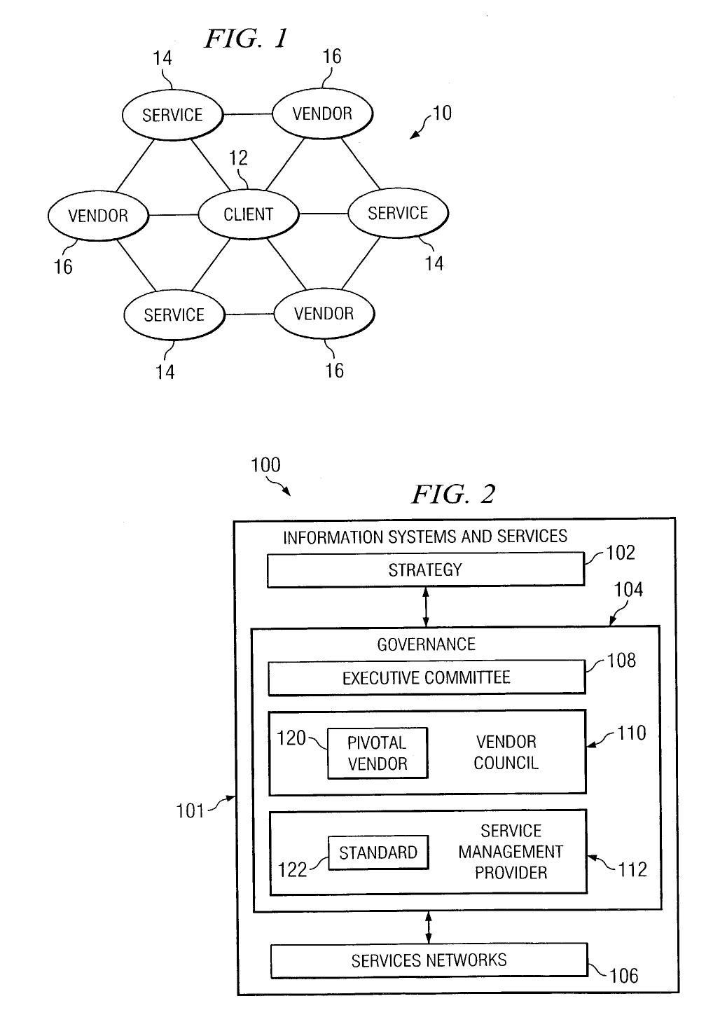

FIG. 1 is a graph illustrating a multi-vendor outsourcing environment 10. In environment 10, a client 12 may receive one or more outsourced services 14 from one or more vendors 16.

Client 12 comprises a business, organization or other group that receives services 14 from vendors 16. For example, client 12 may comprise a large corporation which contracts for various services 14 from many third-party vendors 16. Client 12 may outsource these services to, for example, decrease costs and control employee headcount.

Service 14 comprises suitable services and products that may be outsourced by client 12 and provided by vendors 16. For example, services 14 may comprise various information technology (IT) services provided by vendors 16 to client 12 in support of the client's information technology needs. In general, services 14 may comprise a suitable combination of services, products and/or other items and concepts that may be provided to client 12 by vendor 16.

Vendor 16 comprises a company, organization or other group capable of providing services 14 to client 12. For example, vendor 16 may comprise a company which has contracted with client 12 to provide information technology services, such as phone, computer and network support, to client 12.

Environment 10 may represent a business situation where client 12 outsources various responsibilities to vendors 16. Client 12 may outsource services 14 to vendors 16 in order to control the costs associated with providing services 14. For example, client 12 may be a large corporation which has determined that handling IT services internally is more expensive than hiring an outside vendor to provide these services. Various vendors 16 may provide various services 14 in different ways. For example, if a first vendor is handling workstation configuration while a second vendor is handling network operations and monitoring, the first vendor may report problems in one format while the second vendor reports problems in a second, incompatible format. Also, as multiple vendors 16 may be working together to provide a particular service 14 or portions of service 14, differences between vendors 16 may impact their availability to provide service 14 to client 12. For example, if two vendors 16 are providing external data communication services, the two vendors 16 may report network outages differently. The different reporting standards may decrease the vendors' ability to work together and decrease the quality of services provided to client 12.

FIG. 2 is a block diagram illustrating a vendor management system 100. System 100 may be used by client 12 to manage vendors 16. System 100 may be used to manage all or a subset of vendors 16. For example, the quality and/or amount of services 14 may be increased by system 100. System 100 comprises a client group 101, a strategy 102, a governance body 104, and one or more particular services 106 associated with client group 101.

Client group 101 comprises all or a portion of client 12 receiving services 106 from vendors 16. Vendors 16 may be managed using system 100 and the management of vendors 16 by system 100 may be associated with strategy 102, governance 104 and services 106. For example, client group 101 may comprise an information systems and services group within client 12.

Strategy 102 comprises one or more strategic directions of client group 101. Strategy 102 may be based on business goals, technical issues, and/or other suitable criteria. For example, strategy 102 may involve switching from a wire-based local area network (LAN) to a wireless LAN for employees of group 101 who travel frequently.

Governance body 104 comprises one or more groups for managing services 106 and vendors 16 with respect to client group 101. For example, client 12 may create governance body 104 while implementing system 100 to increase the quality of services 14 in environment 10. In one embodiment, governance body 104 comprises an executive committee 108, a vendor council 110, and a service management provider 112.

Executive committee 108 comprises a portion of governance body 104 responsible for determining strategy 102. Executive committee 108 may further be responsible for aligning the business objectives of client 12 and using these objectives in making decisions with respect to services 14 and vendors 16. Executive committee 108 may further be responsible for establishing policies for vendors 16 and services 14, such as metrics for measuring performance of vendors 16, selecting new technology, and working to increase customer satisfaction and market share for client 12 and/or group 101. In one embodiment, executive committee 108 may include executives from client 12 and principal vendors 16. For example, membership of executive committee 108 may be responsible for strategic direction and planning with respect to IT, strategic relationship decisions, strategic initiatives, resolutions of high priority issues, and managing risks associated with environment 10. In general, executive committee 108 may handle one or none of these responsibilities in suitable combination as appropriate for client 12 and/or group 101.

Vendor council 110 comprises a portion of governance body 104 responsible for managing vendors 16. In one embodiment, vendor council 110 may be responsible for communicating common policy, strategy and direction information to vendors 16, verifying vendor readiness for changes, resolving multi-party conflicts, reviewing vendor related metrics and reviewing schedules. Vendor council 110 may further be responsible for validating, adapting, designing, updating, adopting and/or administering common processes for service management providers 112 and vendors 16. For example, common processes may involve incident management, problem management and change management.

In one embodiment, membership of vendor council 110 comprises one or more pivotal vendors 120 to client 12. Pivotal vendor 120 may comprise a vendor 16 considered by client 12 to be particularly important to client 12. For example, pivotal vendor 120 may comprise a best-in-class vendor 16, a vendor 16 responsible for a significant number of services 14 and/or a vendor selected by client 12 according to suitable criteria. Membership of vendor council 110 may further include one or more employees of client 12. In one embodiment, membership of vendor council 110 totals approximately 15 members, including pivotal vendors 120 and employees of client 12.

Service management provider 112 comprises an organization, company or other group for providing management of service delivery, processes and procedures for client 12 and/or client group 101. Service management provider 112 may manage both strategic level issues and detail level issues in suitable combination as appropriate for client 12 and/or group 101. For example, service management provider 112 may comprise a company for managing vendors 16. In one embodiment, service management provider 112 receives direction from vendor council 110, implements processes and procedures selected and/or approved by vendor council 110 for use with vendors 16, adopts tools for use with services 106 to increase integration between vendors 16, manages quality assurance with respect to problems and changes, provides improvement suggestions to vendor council 110, and escalates issues for resolution to vendor council 110. For example, if services 106 are IT-related services, service management provider 112 may administer and report compliance of vendors 16 with service level agreements (SLA) between various IT vendors and coordinate enterprise system operations issues. The SLA may comprise an agreement to provide a particular level of service from vendor 16 to client 12. For example, the SLA may specify that repairs to a computer will be completed within 24 hours. For another example, an SLA may specify that vendor 16 will provide a certain amount of data communications bandwidth to client 12 and that the bandwidth will be available 99.95% of the time. Table 1 illustrates one exemplary distribution of responsibilities between executive committee 108, vendor council 110 and service management provider 112.

TABLE 1
Exemplary Responsibilities for Governing Board

| | | | | Service |
|---|---|---|---|---|
| | | Executive | Vendor | Manage- |
| | Responsibilities | Committee | Council | ment |
| Strategy | Strategic direction | Approve | Recommend | Implement |
| | Operation plan | Approve | Recommend | Implement |
| | Technology | Oversee | Manage | Implement |
| | Policy | | | |
| Operation | Performance | Oversee | Manage | Report |
| | measurement | | | |
| | Issue | | Prioritize | Manage |
| | identification | | Resolve | & Report |
| | Resolution - | Resolve | Identity | Identity |
| | strategic issues | | Recommend | |
| | Resolution - | Informed | Resolve⁽²⁾ | Resolve⁽³⁾ |
| | operational issue | | Informed⁽³⁾ | |
| Initiatives | Opportunity | Informed | Oversee | Identity |
| | identification | | | Manage |
| | Resource | Approve | Recommend⁽¹⁾ | Implement |
| | allocation | | Approve⁽⁴⁾ | |
| | Project | Informed | Oversee | Manage |
| | management | | | |
| | Issue | | Prioritize | Manage |
| | identification | | Resolve | & Report |
| | Resolution - | Resolve | Recommend | Report |
| | strategic issues | | | |
| | Resolution - | Informed | Resolve⁽²⁾ | Identity |
| | operational issues | | Informed⁽³⁾ | Resolve |

⁽¹⁾ Strategic
⁽²⁾ High Level
⁽³⁾ Low Level
⁽⁴⁾ Non Strategic

In general, service management provider 112 determines one or more standards 122. Standards 122 comprise processes, procedures, strategies and other items and activities associated with vendor-related and service-related goals of client 12. For example, standard 122 may comprise minimum requirements for SLAs associated with vendors 16.

Group services 106 comprise particular services 14 provided by vendors 16 to group 101 according to one embodiment of the present invention. In one exemplary embodiment, services 14 comprise IT-related services such as telecommunications and network services.

In operation, executive committee 108 determines strategy 102 for client 12. Vendor council 110 uses strategy 102 and other directives from executive committee 108 to formulate policies and procedures to be followed by vendors 16. More specifically, pivotal vendors 120 come to agreement on standards 122 to be followed by vendors 16. For example, when vendors 16 are providing IT-related services, such as network management, vendor council 110 may determine a common problem tracking and reporting format for network problems for use by vendors 16. The use of common reporting formats may increase the quality of services provided by vendors 16 by decreasing confusion and increasing consistency. For example, a network problem which spans multiple vendors 16 may involve only a single trouble ticket, as opposed to multiple trouble tickets from different vendors 16 for handling the problem.

Vendor council 110 may determine the standards 122 by coming to agreement between pivotal vendors 120 and then requiring compliance by vendors 16. For example, client 12 may require compliance with the standards before allowing vendor 16 to do business with client 12.

Service management providers 112 then provide management of policies and procedures selected and/or approved by vendor council 110 with respect to vendors 16. More specifically, service management provider 112 may provide a single group responsible for implementation of the procedures among vendors 16. For example, service management provider 112 may interact with vendor representatives to achieve compliance with standards 122, such as IT Infrastructure Library (ITIL) standards.

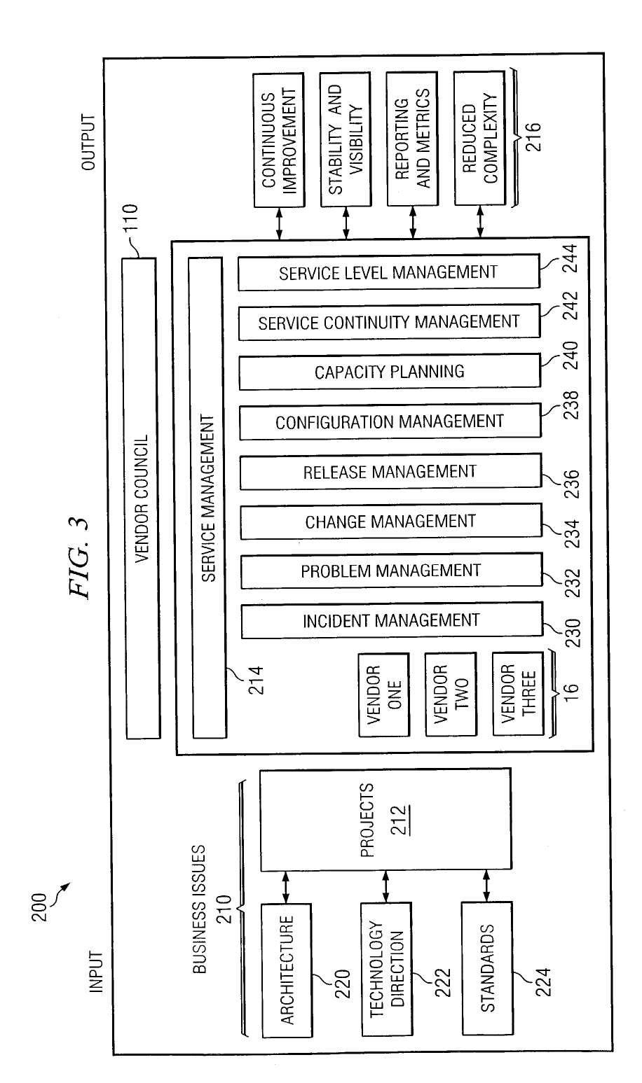

FIG. 3 is a block diagram illustrating a service management model 200 according to one embodiment of the present invention. In the embodiment illustrated in FIG. 3, model 200 is described in association with IT-related technology, however, model 200 may be used in any suitable environment. Model 200 comprises one or more business issues 210, one or more projects 212, a service management architecture 214, and one or more benefits 216. Business issues 210 may comprise architecture issues 220, technology direction issues 222, and standards issues 224.

Architecture issues 220 may comprise technical issues related to the architecture of computer networks, computer systems and/or computer software with respect to business issues associated with client 12. For example, architecture issues 220 may comprise LAN and wide area networks (WAN) design issues for a large, geographically dispersed corporation.

Technology direction issues 222 may comprise forward looking and future planning related issues with respect to technology. For example, technology direction issues 222 may involve whether client 12 should move toward a distributed or centralized data management system.

Standards issues 224 may comprise technical issues with respect to the standardization of components, technology, design or other issues associated with the technology infrastructure of client 12. For example, client 12 may have issues with respect to whether client 12 is standardizing around a Microsoft Windows™ architecture, a Unix™ based architecture or a Macintosh™ based architecture.

In general, business issues 210 comprise business related concerns of client 12 that involve services 14 that may be outsourced to vendors 16. For example, client 12 may determine that in order to increase market share, client 12 should outsource marketing functions to a vendor 16 so that marketing may be accomplished at a decreased cost to client 12. Handling of business issues 210 may involve management of multiple vendors 16 using model 200.

Projects 212 comprise one or more activities, initiatives or other programs used by client 12 with respect to business issues 210. For example, architecture 220 may indicate the use of wireless networks to support mobile employees of client 12, technology direction 222 may indicate a future move to laptops for these mobile employees, and standards issues 224 may indicate that 802.11(b) wireless networks are to be used as part of a company-wide technology modernization project 212.

Service management 214 illustrates one example of various management techniques for managing services 14 provided by vendors 16. In one embodiment, service management 214 involves managing one or more vendors 16 using incident management 230, problem management 232, change management 234, release management 236, configuration management 238, capacity planning management 240, service continuity management 242, and service level management 244.

Incident management 230 may comprise, in one embodiment, detection, monitoring, tracking, communicating and escalation of incidents to executive committee 118 and/or client 12 if the incident is not resolved within an expected time frame. Incident management 230 may further comprise providing a single point of contact for vendors 16 to report issues, and taking ownership of issues through resolution and recovery of the issue. For example, incident management 230 may involve classification of an issue and initial support of the issue, such as classifying the severity of the network outage, communicating staff information to employees, and escalation of the issue to appropriate contacts, such as by contacting vendors 16 responsible for the network and requesting repair of the network issue.

Problem management 232, in one embodiment, comprises monitoring problems to determine a root cause of the problem, recording the root cause and escalating non-compliance with an SLA by vendor 16. More specifically, problem management 232 may comprise investigating and diagnosing problems, identifying known errors, resolving errors by requesting change and validating the implementation of the changes to correct the error. Further, problem management 232 may comprise proactive problem management techniques including analyzing trends and reviewing problems to attempt to decrease future problems.

Change management 234, in one embodiment, may involve handling changes using standard methods and procedures change management 234 may further include evaluating changes to determine risk and impact upon users and other systems to balance the usefulness of the change versus the impact of the change. For example, change management 234 may comprise logging, planning, authorizing, scheduling and reporting changes. In addition, change management may involve defining acceptance criteria, such as a back-out plan, and managing meetings regarding changes. Also, change management 234 may comprise coordinating the building, testing, implementation and evaluation of the changes. In general, changes may involve a change in technology, procedures, or other suitable elements of client 12. For example, in an IT environment, a change may involve switching from one version of a computer operating system to another version of the computer operating system and the impact of the change upon impacted environments may be evaluated.

Release management 236, in one embodiment, may comprise managing technical and non-technical aspects of a product release. For example, release management 236 may involve designing, building, configuring, testing and implementing the release of a product or service of client 12. For example, if client 12 is a technology company, release management 236 may handle the release of a new software package and involve management of both the technical release of the software package, and the non-technical marketing, training and distribution issues. In general, release management 236 involves management of the release of a product or service either alone or is suitable combination.

Configuration management 238 may comprise, in one embodiment, identifying, recording and reporting of one or more items, the constituent elements of the items and the relationships between the items. The items may comprise both physical, such as computer hardware, and/or non-physical items, such as warranties. For example, in an IT-related environment, configuration management 238 may involve IT components, including hardware, software and associated documentation, and including version, sub-component and relationship information. More specifically, configuration management 238 involves identifying configuration items, recording changes to a central database, identifying configuration items required for proper operation, and auditing the central database.

Configuration management 238 may further comprise defining the level of detail of information to be tracked with respect to configuration items and recording attribute, relationship and dependency information with respect to the configuration items. In an information technology embodiment, the configuration items may comprise hardware and software used by client 12 and/or vendors 16 to provide services 14. For example, one configuration item may be file servers used by client 12 to store and provide information to employees.

Capacity planning management 240 may comprise, in one embodiment, understanding and managing business requirements, operations and infrastructure, and evaluating current and future capacity and performance. For example, in an IT-related embodiment, capacity planning management 240 may comprise managing and planning with respect to a business's current and future requirements such that the IT infrastructure has sufficient capacity and performance to support the business requirements of client 12. More specifically, capacity planning management 240 may comprise planning resource utilization requirements, monitoring of performance, forecasting future requirements, and generating a plan with respect to future capacity handling. For example, available network bandwidth and central server processing power may need to be increased to maintain present performance levels as client 12 increases in size. For example, as vendors 16 expand operations to provide services 14 to multiple clients 12, capacity planning management 240 may involve determining whether the vendor 16 has capacity to handle both existing and new clients at expected levels of performance.

Service continuity management 242 may comprise, in one embodiment, disaster recovery processes and planning to support recovery of services and capabilities within appropriate timeframes. More specifically, service continuity management 242 may comprise establishing a hierarchy for invoking disaster recovery plans, coordinating regular disaster recovery testing, and monitoring and reporting on the outcome of the disaster recovery testing. Service continuity management 242 may further comprise identifying gaps in the disaster recovery plan, coordinating execution of the disaster recovery plan during a disaster and managing restoration of service after a disaster. Also, service continuity management 242 may comprise performing risk assessment and training of participants in the disaster recovery plan. For example, in an IT-related environment, service continuity management 242 may involve recovery plans to recover from the loss of a network operations center and/or file servers due to flooding.

Service level management 244 comprises, in one embodiment, maintaining SLAs. More specifically, service level management 244 may comprise reviewing agreed to service levels, escalating instances of failure to maintain the agreed upon level of service to vendor council 110, determine a service level report form, and auditing compliance with SLAs by vendors 16.

Benefits 216 comprise benefits that may be realized from use of service management techniques 214. For example, service management techniques 214 may result in various benefits 216 such as continuous improvement of processes, and increased stability and visibility for projects 212 managed using service management techniques 214. Benefits 216 may further comprise improved reporting capabilities, and metric tracking and definition capabilities with respect to projects 212 managed by service management techniques 214. Also, benefits 216 may include reduced complexity of future projects 212 managed using service management techniques 214, which may draw upon expertise and knowledge gained in previous projects 212. Further, reduced complexity may be achieved through consistent reporting and standards across client 12 for vendors 16.

In operation, vendor council 110 determines various business issues 210 and their relationship to projects 212. For example, a technology modernization project 212 at client 12 may be related to the business issue 210 of the acquisition by client 12 of another company. Vendor council 110 uses service management techniques 214 to manage various vendors 16 with respect to services 14. More specifically, vendor council 110 and/or service management provider 112 may use incident management 230 to deal with high severity incidents. For example, a high severity incident may be the loss of LAN functionality at client 12. Service management provider 112 may also determine standards 122 defining thresholds to separate severe incidents from non-severe incidents and so that vendors 16 have a consistent definition of a serious incident. Vendor council 110 may also require vendors 16 to follow a defined incident management process when an incident is detected. In one embodiment, vendors 16 are responsible for detecting incidents related to services 14 provided by that vendors 16.

As a portion of problem management 232, service management provider may identify severe incidents and use problem management 232 to identify a fix for the incident. In one embodiment, vendor 16 performs the investigation, diagnosis and solution determination of problems related to services 14 provided by that vendor 16. Problem management software may be used in support of problem management 232 to track and manage problems identified by service management provider 112, client 12 and/or vendors 16. Problem management 232 may involve selecting particular service related issues so as to appropriately address serious issues. Service management provider 112 may define particular rules to be followed by vendors 16 when vendors 16 perform problem management. For example, service management provider 112 may require that all vendors 16 use the problem management tool selected by service management provider 112 and provide information in a format compatible with the problem management tool.

Change management 234 manages changes to equipment, personnel, projects 212 and/or other elements of client 12. Change management may use information in a central database to assess the risk and impact of a proposed change and update the central database to reflect changes which have been implemented. Various levels of change advisory boards (CAB) may have differing levels of authority to allow changes to be dealt with at an appropriate level of authority. For example, a minor change in the organization of one particular programming team may be handled on a very low level while company-wide changes in technology may be handled at a high level. The change advisory boards may provide summaries to their superior and subordinate change advisory boards to increase the consistency and the visibility of changes.

Service management provider 112 may be in charge of release management 236 to support compliance with release management related standards 122 generated by service management provider 112 and vendor council 110. Client 12 may be responsible for deciding on the content and schedule of particular releases and providing appropriate business requirement information to support use of release management 236 with products and services of client 12.

Information related to services 14 provided by vendors 16 may be collected and stored as part of configuration management 238. The collected data may be used as a foundation for other reporting and analysis services based on the data, such as change management 234. For example, the data may indicate the relationships between the IT components between different vendors 16 providing IT services to client 12.

Service management provider 112 may then define process and data template standards 122 for use by vendors 16 as part of capacity management 240. More specifically, the processes and data templates may define standardized capacity planning reports so that information from multiple vendors 16 may be correlated by service management provider 112 to provide more consistent service to client 12. For example, the ability to plan for future capacity needs may be hampered by incompatible reporting formats from various vendors 16.

Next, service management provider 112 may use service continuity management 242 to determine a disaster recovery plan across multiple vendors 16. For example, vendors 16 may be required to report disaster recovery plans for the particular services 14 provided by vendors 16 and service management provider 112 may unify these disaster recovery plans for increased effectiveness.

Service management provider 112 may then evaluate each SLA client 12 has negotiated with each vendor 16. Service management provider 112 may continuously audit vendors 16 for compliance of SLAs and work to resolve failures of vendors 16 to meet SLA commitments.

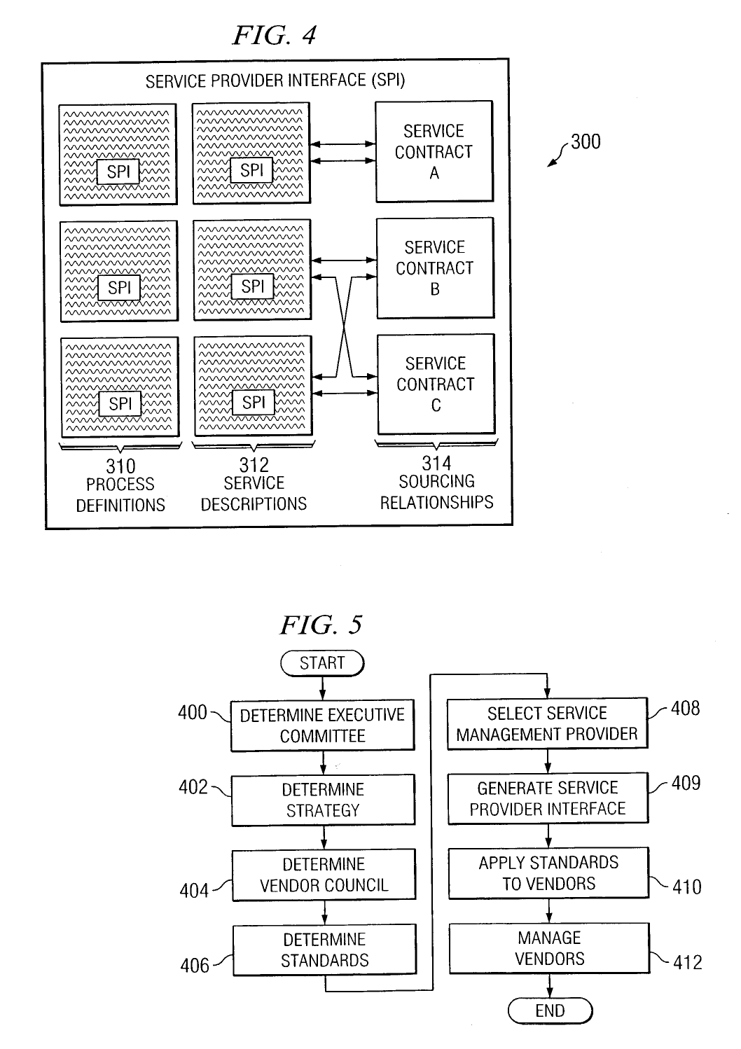

FIG. 4 is a block diagram illustrating a Service Provider Interface (SPI) 300 according to one embodiment of the present invention. SPI 300 comprises a contract or other enforceable agreement, or a portion thereof, between client 12 and a vendor 16. For example, SPI 300 may specify data, procedural, event, organizational, and technology interface points for management processes 214 and standards 122 associated with service 14. SPI 300 may be developed using change management 234. SPI 300 may specify standards 122 and procedures with respect to change management 234, problem management 232, service continuity management 242 and other areas associated with vendors 16. In one embodiment, SPI 300 may be included as part of a legal contract for services 14 between client 12 and vendor 16. More specifically, SPI 300 may comprise one or more process definitions 310, one or more service descriptions 312, and one or more sourcing relationships 314.

Process definitions 310 may comprise standards, procedures, reporting formats, and other standards vendor 16 is expected to comply with. Service description 312 may comprise a description of the actual service 14 being provided by vendor 16. For example, service description 312 may comprise a portion of a contract for service 14 between client 12 and vendor 16 which describes the services to be governed by process definitions 310. Sourcing relationships 314 may comprise a description of the relationships between multiple vendors 16 and/or multiple services 14 being provided by the one or more vendors associated with SPI 300 and controlled by process definitions 310. For example, sourcing relationships 314 may describe the relationships between the network support services and the data communications services being provided by vendor 16. For another example, sourcing relationships 314 may describe the relationship between the data communications services being provided by a first vendor and the network monitoring services being provided by a second vendor.

In one embodiment, SPI 300 may describe one or more technology prerequisites, such as management tool standards and prescribed protocols. Further, SPI 300 may describe non-negotiable requirements, such as practices, activities and operating procedures, and required roles and responsibilities within the vendor's and/or client's organization. Also, SPI 300 may describe required response times and escalation procedures. SPI 300 may additionally identify integration points between the management processes of vendor 16 and client 12, specific roles and responsibilities for managing the ongoing systems management relationship between client 12 and vendor 16, and relevant systems management information to be available to client 12, such as communication of event and status information to an enterprise business process monitor. In general, SPI 300 may describe and/or require various responsibilities and procedures to be followed by vendor 16 and/or client 12 as part of the contractual obligations between client 12 and vendors 16.

In operation, SPIs 300 may be used by governance board 104 and service management provider 112 to enforce the use of standard practices, forms, formats and other standards 122 among various vendors 16. For example, SPI 300 may indicate that service management provider 112 has authority to enforce compliance by vendors 106 with standards generated by client 12, such as by vendor council 110.

FIG. 5 is a flowchart illustrating an exemplary use of model 200 in environment 10 according to one embodiment. The method begins at step 400 where executive committee 104 is determined by client 12. For example, client 12 may select various executives associated with projects 212 as the members of executive committee 104. In general, client 12 may determine the membership and responsibilities of executive committee 104 as appropriate for client 12. For example, executive committee 104 may have differing responsibilities and size depending on whether client 12 is a large, multi-national corporation or a small company. For another example, executive committee 104 may be responsible for company wide IT issues, or only IT issues related to a particular group or division of client 12.

Next, at step 402, executive committee 104 determines strategy 102. Strategy 102 may be based on general corporate goals, on particular goals selected by executive committee 104 based on the responsibilities of executive committee 104, and/or other suitable criteria. Strategy 102 may address company-wide issues, local issues, and/or other suitable issues as determined by executive committee 104. For example, executive committee 104 may determine that client 12 would benefit from a transition from one application package to another application package and determine the overall strategy for the conversion.

Then, at step 404, vendor council 110 is determined by client 12. For example, vendor council 110 may be selected by executive committee 104, other decision making elements of client 12 and/or a third-party. Pivot vendors 120 are selected by executive committee 104 and the size of vendor council 110 is determined. The responsibilities and authority of vendor council 110 may also be determined.

Proceeding to step 406, vendor council 110 determines one or more standards 122 based on strategy 102. For example, standard 122 may indicate that vendors 16 are to report problems in a particular format with particular information using a particular reporting tool.

Then, at step 408, vendor council 110 selects service management provider 112. Service management provider 112 may be a third-party who has contracted with client 12 to manage vendors 16 and/or may be employees of client 12, either alone or in suitable combination. Vendor council 110 may select service management provider 112 according to suitable criteria. For example, vendor council 110 may select service management provider 112 based on cost, capability, and compatibility with client 12.

Next, at step 409, service management provider 112 generates one or more SPIs 300 for use with vendors 16. SPIs 300 may be generated to implement standards 122. For example, while a particular standard may define reporting formats and management processes to be used by vendors 16, a particular SPI may generated to apply the particular standard to particular vendors providing particular services.

Proceeding to step 410, service management provider 112 applies standards 122 to vendors 16. More specifically, service management provider 112 may negotiate and/or renegotiate contracts, SLAs and other agreements between vendors 16 and client 12 to include SPIs 300. By including SPIs 300, vendors 16 may be contractually and legally bound to follow standards 122.

Then, at step 412, service management provider 112 manages services 14 using SPIs 300 and service management techniques 214. For example, problem management 232 may involve particular procedures defined in a particular standard and implemented in various SPIs with appropriate vendors 16. Service management provider 112 may use the particular procedures to resolve problems with particular services 14 provided by particular vendors 16.

Various portions of system 100 may be supported by logic encoded on a computer readable medium, such as software encoded on a magnetic or optical medium and executable by a processor, or logic encoded in hardware, such as an Application Specific Integrated Circuit (ASIC). For example, logic may be used to store and track data associated with the relationships between vendors. For another example, logic may be used to track whether vendors 16 are complying with SPIs 300, such as SLAs and minimum bandwidth requirements for data communications vendors.

Managing multiple vendors with respect to their client may provide the client with increased knowledge of the performance and capabilities of the vendors. For example, an end-to-end view of multi-vendor services may be provided to the client to improve the decision making abilities of the client with respect to those services. Also, the client's ability to control costs may be increased as the client's knowledge of the vendors is increased. For example, the client may be able to eliminate redundant vendors and services.

Other changes, substitutions, and alterations are also possible without departing from the spirit and scope of the present invention, as defined by the following claims.

What is claimed is:

1. A method for vendor management comprising:
determining a standard associated with a service and a client;
applying, by a service management provider, the standard to a first vendor associated with the service; and
managing, by the service management provider, compliance with the standard by the first vendor.

2. The method for vendor management according to claim 1 and further comprising communicating, by the service management provider, data associated with the service based on a format associated with the standard to the client.

3. The method for vendor management according to claim 1 and further comprising generating a service provider interface based on the standard and the service, the service provider interface comprising a portion of a contract between the first vendor and the client and wherein the service provider interface comprises a process definition portion, the process definition portion defining at least one management process to be followed by the first vendor.

4. The method for vendor management according to claim 3 and further comprising:
determining at least one relationship between the first vendor and a second vendor, the second vendor being associated with the service; and
generating a sourcing relationships portion of the service provider interface such that the relationship between the first vendor, the second vendor and the client is defined with respect to the service.

5. The method for vendor management according to claim 1, wherein generating the standard comprises:
determining, by an executive committee associated with the client, a strategy;
determining, by a vendor council, the standard based on the strategy; and
wherein the vendor council comprises at least one pivotal vendor.

6. The method for vendor management according to claim 1, wherein managing the first vendor comprises managing, by the service management provider, the first vendor according to at least one of an incident management technique, a problem management technique, a change management technique, a release management technique, a configuration management technique, a capacity planning management technique, a service continuity management technique and a service level management technique.

7. The method for vendor management according to claim 1 wherein the standard specifies a management process.

8. The method for vendor management according to claim 7, wherein the management process is associated with network management.

9. The method for vendor management according to claim 1, wherein applying the standard comprises:
auditing, by the service management provider, compliance with the standard by the first vendor and at least one second vendor distinct from the first vendor;
escalating, by the service management provider, non-compliance with the standard by either of the first or second vendors to the client; and
resolving, by the service management provider, non-compliance with the standard.

10. The method for vendor management according to claim 1, wherein the standard is applied to the first vendor and at least one second vendor distinct from the first vendor and associated with the service.

11. A system for vendor management comprising:
logic encoded on a computer readable medium and operable to:
store data associated with a standard associated with a first vendor, a second vendor, a service, and a client;
track compliance with the standard by the first and second vendors; and
notify a service management provider of lack of compliance with the standard by either of the first and second vendors.

12. The system according to claim 11, wherein the standard comprises a service provider interface.
